(19) United States
(12) Patent Application Publication
(10) Pub. No.: US 2022/0316926 A1
(43) Pub. Date: Oct. 6, 2022

(54) HIGH-TEMPERATURE FLOW SENSOR PROBE

(71) Applicant: SPORIAN MICROSYSTEMS, INC., Lafayette, CO (US)

(72) Inventors: JON LUBBERS, Lafayette, CO (US); Brittany McGrogan, Denver, CO (US); Duc Nguyen, Lakewood, CO (US); Bradley Smith, Westminster, CO (US); William VanHoose, Aurora, CO (US)

(21) Appl. No.: 17/219,301

(22) Filed: Mar. 31, 2021

(51) Int. Cl. G01F 1/69; H01R 4/62; H01C 17/00

(52) U.S. Cl. CPC G01F 1/69; H01R 4/62; H01C 17/00

(57) ABSTRACT

A high-temperature flow sensor includes strain relief wires for connecting cable wires to electrically resistive sensor elements to protect the sensor elements from fractures or other damage due to differences in thermal expansion and contraction of components. The resistive sensor material assembled with a support material is mounted in a tube with an electrically, conductive filler between the sensor material and the tube.

### GOVERNMENT LICENSE RIGHTS

This invention was made with government support under Contract No. DE-SC0013858 awarded by the United States Department of Energy. The government has certain rights in the invention.

### BACKGROUND

### Technical Field of the Invention

The present invention is related to flow sensors and more specifically to features that enhance durability and sensitivity of flow sensors in high temperature applications.

### State of the Prior Art

Flow sensors that operate based on convective cooling of electrical resistive elements in which the resistivity is temperature-dependent are well-known, including some for use in high temperatures, for example, as high as 1,800° C., sometimes even in corrosive, oxidizing, or reducing fluids, neutron flux, or other harsh conditions, for example, as described in the Patent Application Publication No. US 2020/0499477 A1, which is incorporated herein by reference for all that it discloses. However, improvements in durability, responsiveness, and accuracy are still desirable.

The foregoing examples of the related art and limitations related therewith are intended to be illustrative and not exclusive. Other limitations of the related art and other examples of related art will become apparent to those of skill in the art upon a reading of the specification and a study of the drawings.

### SUMMARY

The following embodiments and aspects thereof are described and illustrated in conjunction with systems, tools, and methods which are meant to be examples and illustrative, not limiting in scope. In various embodiments and implementations, one or more problems have been reduced or eliminated, while other embodiments are directed to other improvements and benefits.

A method of connecting a wire that is subject to thermal expansion and contraction to an electrically conductive element that is subject to fracture when subjected to tensile or compressive stresses and strains comprises joining one end of a length of strain relief wire, which has a bend, with the wire that is subject to thermal expansion and contraction, and joining another end of the length of strain relief wire to the electrically conductive element that is subject to the thermal expansion and contraction.

In one embodiment of the method, the length of strain relief wire has small enough stiffness to flex in response to the thermal expansion and contraction of the wire that is subject to the thermal expansion and contraction.

In another embodiment, the bend has a coil shape.

In another embodiment, the bend has a loop shape.

In another embodiment, the bend has a bow shape.

In another embodiment, the bend has a double-bowed shape.

A method of assembling an electrically resistive sensor element in a tube comprises injecting a paste comprising a powder of a thermally conductive fill material mixed with a binder into the tube, forcing the electrically resistive sensor element into the tube to thereby force the paste to flow around the electrically resistive sensor in a gap between the electrically resistive sensor element and the tube, and heating the paste to drive off volatile binder material and to bond the thermally conductive fill material to the resistive sensor element and the tube.

One embodiment of the method includes injecting a sufficient quantity of the paste into the tube so that forcing the electrically resistive sensor element into the tube causes the paste to essentially fill the gap.

Sensor apparatus comprises an electrically resistive sensor element, a cable wire that is subject to thermal expansion and contraction, and a length of strain relief wire which has a bend between two ends, wherein one of the two ends is joined to the cable wire and another of the two ends is joined to the electrically resistive sensor element.

In one embodiment of the apparatus, the length of strain relief wire which has the bend has small enough stiffness to flex in response to thermal expansion and contraction of the cable wire.

In another embodiment, the bend has a coil shape.

In another embodiment, the bend has a loop shape.

In another embodiment, the bend has a bow shape.

In another embodiment, the bend has a double-bowed shape.

Sensor apparatus comprises an electrically resistive sensor element positioned in a tube with a gap between the electrically resistive sensor element and the tube, and a thermally conductive fill material in the gap.

In one embodiment, the thermally conductive fill material fills the gap.

An electrical device comprises an electrically resistive element, a thermally expandable and contractable wire, and a length of strain relief wire which has a bend between two ends, wherein one of the two ends is joined to the thermally expandable and contractable wire and another of the two ends is joined to the electrically resistive element.

In one embodiment of the device, the length of strain relief wire has small enough stiffness to flex in response to thermal expansion and contraction of the thermally expandable and contractable wire and support structure.

In addition to the example aspects, embodiments, and implementations described above, further aspects, embodiments, and implementations will become apparent to persons skilled in the art after becoming familiar with the drawings and study of the following descriptions.

### BRIEF DESCRIPTION OF THE DRAWINGS

The accompanying drawings, which are incorporated herein and form a part of the specification, illustrate some, but not the only or exclusive, example embodiments and/or features. It is intended that the embodiments and figures disclosed herein are to be considered illustrative rather than limiting. In the drawings:

FIG. 1 is an isometric view of an example high temperature flow sensor probe;

FIG. 2 is a top plan view of the example high temperature flow sensor probe in FIG. 1 with a portion of the casing cut away to reveal the wire connections of the temperature sensors to the supply cable;

FIG. 3 is an enlarged view of the cut-away portion of the example high temperature flow sensor probe;

FIG. 4 is an enlarged view of an example strain relief wire bend;

FIG. 5 is an enlarged view of another example strain relief wire bend;

FIG. 6 is an enlarged view of another example strain relief wire bend;

FIG. 7 is an enlarged view of another example strain relief wire bend; and

FIG. 8 is an enlarged view of another example strain relief wire bend.

### DETAILED DESCRIPTIONS OF EXAMPLE EMBODIMENTS

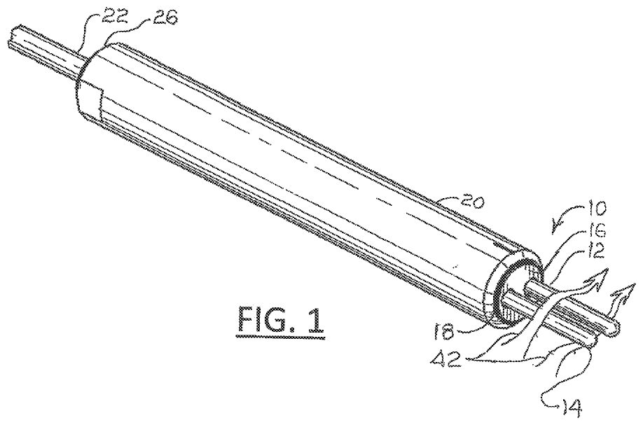

An example high temperature flow sensor probe 10 is illustrated diagrammatically in FIGS. 1-3. Persons skilled in the art are familiar with flow sensor probes in which a resistive sensing element is heated with electric current, and the electrical resistance of the resistive sensing element, which is temperature-dependent, is correlated to mass flow rate through the temperature coefficient of resistivity and convective cooling, which is a fundamental operating principle of thermal anemometry. However, applications of such thermal anemometry principles to high temperature fluids, e.g., 650° C. to 1,800° C., face challenges due to limitations and characteristics of materials that can withstand such high temperatures.

The example flow sensor probe 10 comprises a flow-sensing component 12 and a temperature sensing component 14 mounted in, and extending side-by-side from, a double hole bushing 16 in the distal end 18 of a protective casing 20, although any other convenient mounting structure instead of the example double-hole bushing 16 can be used for mounting the flow-sensing component 12 and the temperature-sensing component 14 at the distal end 18 of the protective casing 20 as would be well within the capabilities of persons skilled in the art. A cable 22, e.g., a mineral insulated cable, with a plurality of electric wires is mounted in a single hole bushing 24 in the proximal end 26 of the casing 20 and extends through the casing 20 toward the distal end 18 of the casing 20 in the proximity of the flow-sensing component 12 and the temperature sensing component 14. In the example flow sensor probe 10, the cable 22 has eight wires 31, 32, 33, 34, 35, 36, 37, 38, various ones of which are connected to the flow-sensing component 12 and to the temperature sensing component 14 as will be explained in more detail below. The cable 22 and wires 31, 32, 33, 34, 35, 36, 37, 38 extend from the proximal end 26 of the casing 20 to electronics (not shown) that provide power and signal sensing for the flow-sensing component 12 and the temperature sensing component 14. Such electronics are well-know to persons skilled in the art, and details of such electronics are not needed for this description of the example flow sensor probe 10. The flow-sensing component 12 comprises an electrically resistive flow-sensing element 40 that is heated with electric current, and the electrical resistance of the flow-sensing element 40, which is temperature-dependent, is correlated to mass flow rate through the temperature coefficient of resistivity of the flow-sensing element 40 and convective cooling by a flowing fluid as indicated by the flow arrow 42 in FIG. 1. The temperature-sensing component 14 is used to obtain a measurement of the fluid temperature for temperature compensation, e.g., correction of voltage or current measurements from the flow-sensing component 12 for effects of temperature on those measurements, in order to obtain more accurate fluid-flow measurements, as is well-understood by persons skilled in the art.

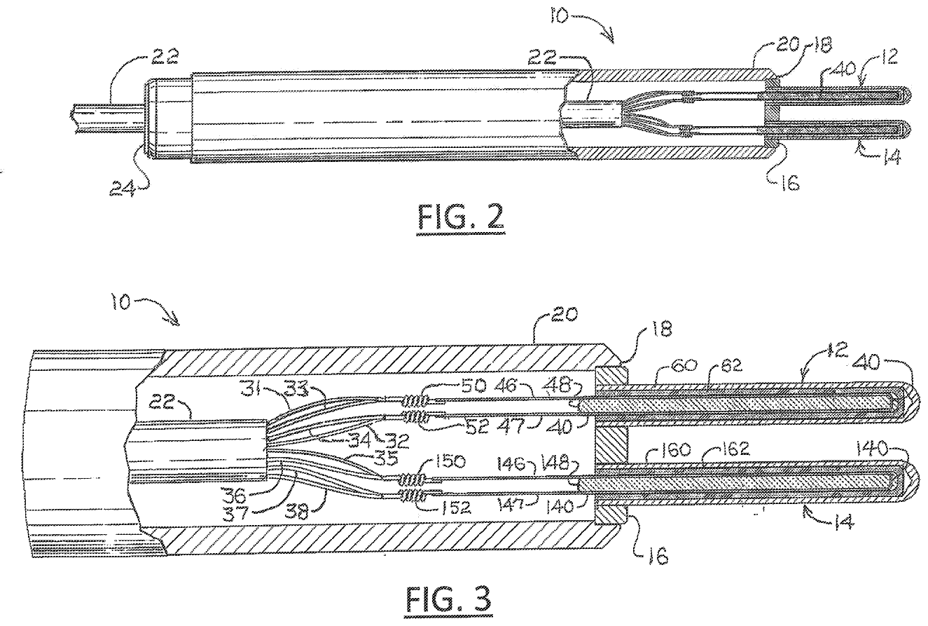

The flow-sensing element 40 comprises an electrically conductive material that has a resistance and produces heat when electric current flows in it. Therefore, the flow-sensing element 40 is sometimes also referred to herein as “resistive flow-sensing element” and sometimes more generically as a “resistive sensing element,” The resistive sensing element 40 can be provided in myriad structures and configurations, for example, electrically conductive wire or film, that preferably, but not necessarily, has a monotonic temperature coefficient of resistivity. Such electrically conductive materials are available in metals, ceramics, and other materials. The example resistive sensing element 40 illustrated in FIGS. 2 and 3 is illustrated as an electrically conductive wire or film wound or wrapped around and mechanically supported by an electrically insulative core material 48. The resistive sensing element 40 includes a pair of electrically conductive leads 46, 47 extending from opposite ends or sides of the resistive sensing element 40 for connecting electric voltage across, and to flow current through, the resistive sensing element 40. The core material 48 can be any electrically insulative material that is rigid or otherwise supportive for the resistive sensing element 40 and that can withstand the temperatures and other environmental conditions in which the resistive sensing element 40 is intended to be used. For high temperature applications, the core material 48 can be, for example, refractory ceramic oxides, carbides, or nitrides, and the electrically conductive material 46 can be, for example, platinum or nickel.

Electric power from a power source (not shown) is provided to the resistive sensing element 40 by electric wires, e.g., wires 31, 32, that extend through the multiple-wire cable 22 to the interior of the casing 20, where the wires are connected to opposite leads 46, 47, respectively, of the resistive sensing element 40. In the example flow sensor probe 10 in FIGS. 2 and 3, two additional wires, e.g., wires 33, 34 in the multiple-wire cable 22 are also shown connected to the opposite leads 46, 47, respectively, of the resistive sensing element 40 to complete a 4-wire (leg) connection to the resistive sensing element 40. In such a 4-wire sensor arrangement, the two additional wires 33, 34 would connect to voltage sensor electronics (not shown), usually located outside and away from the flow sensor probe 10, to sense voltage across the resistive sensing element 40, which is indicative of flow rate of the flowing fluid 42, as is well understood by persons skilled in the art. Persons skilled in the art also understand that the voltage across the electrical conductor 46 could be sensed with only the two wires 31, 32 for a so-called 2-wire sensor, or just one additional wire, e.g., wire 33, could be connected to one of the leads 46, 47 for a 3-wire sensor arrangement. Persons skilled in the art also understand that a 4-wire arrangement removes confounding effects of resistances in the cable wires to a more accurate measurement of voltage across the resistive sensing element 40 than either a 2-wire or a 3-wire arrangement.

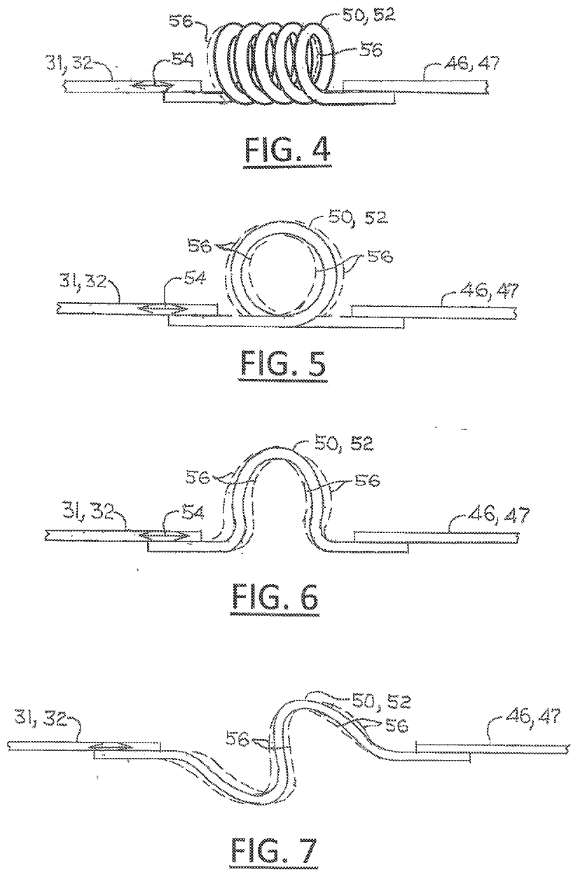

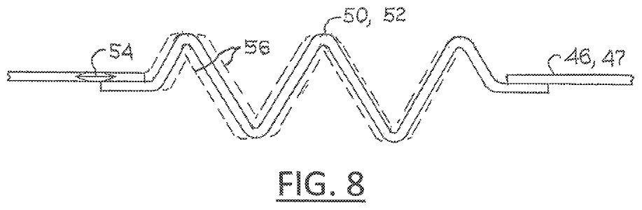

Some electrically conductive materials with monotonic temperature coefficients of resistivity suitable for high temperature applications, e.g., for the flow sensing element 40, including the leads 46, 47, are fairly brittle or become embrittled at high temperatures. Platinum and nickel are examples of such electrically conductive materials. Also, lengths of the cable wires, e cable wires 31, 32, 33, 34, may undergo significant thermal expansion and contraction during heating and cooling, whereas the casing 20, in which the flow-sensing element 40 is mounted, may undergo different magnitudes of expansion and contraction and at different rates than the cable wires. Such differences in magnitudes and rates of thermal expansion and contraction between the cable wires and the casing 20 may be due to differences in the coefficients of thermal expansion of the materials comprising those components. Also, the casing 20 is in direct contact with the high-temperature flowing fluid 42, whereas the cable wires, e.g., cable wires 31, 32, 33, 34, are inside the cable 22, which, itself, is inside the casing 20. Therefore, the casing 20 reaches higher temperature extremes at faster rates than the cable wires, which also contributes to differential magnitudes and rates of thermal expansion and contraction between the cable wires and the casing. Consequently, when the leads 46, 47 of the resistive sensing element 40 are joined to the lengths of cable wires, e.g., cable wires 31, 32, 33, 34, non-uniform thermal expansion and contraction of the cable wires with respect to the casing 20 can cause significant tensile and compressive stresses in the leads 46, 47, which can cause enough strain in the resistive sensing element 40 to fracture the flow sensing element 40 in or adjacent to the leads 46, 47. To alleviate that problem, the cable wires are joined to the leads 46, 47 with lengths of strain relief wires, strain relief wires 50, 52, made of an electrically conductive metal that does not become embrittled at high temperatures or due to work hardening and that are shaped in one or more bend shapes to flex enough, either plastically, elastically, or both, to absorb movement of the cable wires 31, 32, 33, 34 in relation to the leads 46, 47 due to the different rates and magnitudes of thermal expansion and contraction between the casing 20 and the cable wires 31, 32, 33, 34, as will be explained in more detail below. Gold, silver, and copper are examples of such electrically conductive metals that maintain sufficient ductility at high temperatures, e.g., 300° C. to 1,000° C., and under strain that bends of those materials can plastically or elastically deform rather than transmit the axial displacement of the wires 31, 32, 33, 34 to the sensing element leads 46, 47. The strain relief wires 50, 52 are attached at one end to respective ones of the pair of leads 46, 47 and at another end to the respective core wires 31, 32, 33, 34. The lengths of strain relief wires 50, 52 between the respective leads 46, 47 and the respective core wires 31, 32, 33, 34 are not straight. Instead, the strain relief wires 50, 52 are bends, for example, bows, loops, or coils (see examples in FIGS. 4-8) that tend to flex, as indicated diagrammatically by broken lines 56, and thereby absorb the axial displacement 54 of the wires 31, 32, 33, 34 as the wires 31, 32, 33, 34 expand and contract rather than transmit the axial displacement 54 to the leads 46, 47, thereby avoiding strains in the leads 46, 47 or elsewhere in the resistive sensing element 40 that could result in fractures. The strain relief wires 50, 52 in FIGS. 2 and 3 are illustrated as being bent into a coiled shape similar to a coiled spring, an enlarged view of which is shown in FIG. 4. The example strain relief wires 50, 52 in FIG. 5 are illustrated as being bent into a loop shape. The example strain relief wires 50, 52 in FIG. 6 are illustrated as bent into a bow shape. The example strain relief wires 50, 52 in FIG. 7 are illustrated as being bent into a double bowed shape. The example strain relief wires 50, 52 in FIG. 8 are illustrated as being bent into a shape similar to FIG. 7, but with sharper bends.

A particular bend with a particular wire will flex 56 under a particular force for a particular displacement or under a range of forces for a range of displacements according to Hooke's law F=−kx, where F is the force, x is displacement, and k is a proportional constant (sometimes called spring constant) that is a measure of stiffness, as is well understood by persons skilled in the art. A particular strain relief wire with a particular bend shape will have a particular stiffness, i.e., a particular k within a range of displacement x. Therefore, with a particular strain relief wire 50, 52 with a particular bend shape that has a small enough stiffness k so that a force required to flex (displace) the bend is less than an axial force F exerted by an expanding or contracting cable wire or wires 31, 32, 33, 34, then the strain relief wires 50, 52 will flex 56 and absorb the expansion or contraction displacement of the respective cable wires 31, 32, 33, 34 instead of transmitting the thermal expansion or contraction displacement to the respective lead 46, 47 of the resistive sensing element 40. Persons skilled in the art can determine the thermal expansion and contraction forces of a particular composition and length of core wire 30, 31, 33, 34 in particular temperature ranges empirically or by calculations and can select a particular wire, e.g., metal, diameter, and stiffness and a particular bend shape for strain relief wires 50, 52 to flex 56 enough to absorb the thermal expansion and contraction of the core wires 31, 32, 33, 34 in the temperature range either empirically or by calculations, once they understand the principles of protecting the flow sensing element 40 from fractures as explained herein.

With reference again primarily to FIG. 3, the temperature-sensing component 14 is provided to obtain a measurement of the temperature of the fluid 42 (FIG. 1) for which flow rate is being measured with the flow sensor probe 10. As mentioned above, persons skilled in the art understand that flow is measured with a resistive flow-sensing component 12 by flowing an electric current through the resistive flow-sensing element 40 to produce heat, which is transferred to the flowing fluid 42 by convection. The resistivity of the flow-sensing element 40 is a function of the temperature of the flow-sensing element 40, and current flow through the flow-sensing element 40 is a function of the resistivity and the voltage across the flow sensing element. Therefore, to maintain the flow sensing element 40 at a constant temperature as the heat produced by the flow-sensing element 40 is dissipated by convection to the flowing fluid 42, sufficient current has to flowed through the flow-sensing element 40 to maintain the flow-sensing element 40 at a constant temperature. The voltage across the flow-sensing element 40, e.g., between the two leads 46, 47 is a measure of that current, thus indicative of the mass flow rate of the flowing fluid 42. However, the heat transfer from the flow-sensing element 40 to the flowing fluid 42 is sensitive both to the velocity and the temperature of the fluid, so temperature changes of the fluid must be compensated for in order to achieve accurate velocity or mass flow rates, as is well-known by persons skilled in the art. Accordingly, the temperature-sensing component 14 is provided in the flow sensing probe 10 to measure the temperature of the fluid 42 for such compensation. The temperature sensing component 14 can comprise a resistance temperature detector (RTD), a thermocouple, or any other type of temperature sensor. The example temperature sensing component 14 illustrated in FIG. 3 comprises a resistive temperature sensing element the temperature sensing element 140 that is essentially the same as the resistive flow-sensing element 40 of the flow-sensing component 12, except that the temperature-sensing element 140 is driven with a low current to prevent self-heating. Otherwise, the above-description of the flow-sensing element 40, the insulative core material 48, and the leads 46, 47 of the flow-sensing component 12 is also applicable to temperature-sensing element 140, the insulative core material 148, and the leads 146, 147 of the temperature-sensing component 14. Since the temperature-sensing element 140, like the flow-sensing element 40, is an electrically conductive material with a resistance, the temperature-sensing element 140, like the flow-sensing element, is also sometimes referred to herein as “resistive temperature-sensing element” and sometimes more generically as a “resistive sensing element” Also, the above-description of the strain relief wires 50, 52 connecting the cable wires 31, 32, 33, 34 to the leads 46, 47 for the flow-sensing component 12 is also applicable to the strain relief wires 150, 152 connecting the cable wires 35, 36, 37, 38 to the leads 146, 147 for the temperature-sensing component 14. The strain relief wires 50, 52, 150, 152 can be joined to the respective leads 46, 47, 146, 147 by welding, brazing, crimping, swaging, diffusion bonding, or other joining methods know in the art.

While not shown in FIGS. 2 and 3, more than one flow-sensing element 40 can be used in series or in parallel to adjust power requirements and heat dissipation. Also, a separate strain relief wire could be used to connect each of the cable wires 31, 32, 33, 34, 35, 36, 37, 38 to the respective leads 50, 52, 150, 152 if desired. The cable 22 can be mineral insulated cable, which is commercially available with as many cable wires as desired.

As best seen in FIG. 3, the resistive sensor element 40 along with the insulative core material 48 is installed in a protective tube 60. The tube 60 can be good heat conducting material, for example, stainless steel. Any gap between the resistive sensing element 40 and the protective tube 60 can be filled with a high temperature, thermally conductive fill material 62 to aid conduction of heat from the resistive sensor element 40 to the flowing fluid 42 (FIG. 1). The thermally conductive fill material 62 can be, for example, silver, gold, copper, a ceramic material such as graphite, diamond, silicon carbide, or aluminum nitride. The thermally conductive fill material 62 can be prepared as a powder and mixed with a binder liquid to form a paste comprising the electrically conductive fill material. The binder liquid can have a base of wax, water, silicate compounds, or other liquid chemicals. One method of assembling the resistive sensor element 40 together with the insulative core material 48 and the paste in the tube 60 includes injecting or otherwise placing enough of the paste into the tube 60 to fill or partially fill the tube 60 with the paste, and then forcing the resistive sensor element 40 with the insulative core material 48 into the tube 60, thereby forcing the paste comprising the electrically conductive fill material 62 to flow throughout the gap around the resistive sensor element 40 the length of the tube 60. Another assembly method may include coating the resistive sensor element 40 with the paste and then pushing the resistive sensor element 40 together with the insulative core material 48 and the paste into the tube 60. The assembly of the resistive sensor element 40, tube 60, and paste can then be heated to cure the binder material to chemically or mechanically bond the electrically conductive fill material 60 to the resistive sensor element 40 and the inside of the tube 60. The same thermally conductive fill material 162 and assembly process described above can be used for assembling the resistive sensor element 140 and electrically insulative core material 148 together with the protective tube 160 of the temperature-sensing component 14. The flow-sensing component 12 and the temperature-sensing component 14 are mounted in the two-hole hushing 16 as mentioned above, which can also be stainless steel. The flow-sensing component 12 and the temperature-sensing component 14 can be secured in the bushing 16 by welding, brazing, or otherwise joining the tubes 60, 160 to the bushing 16. Of course, the flow-sensing component 12 and the temperature-sensing component 14 can be mounted and secured at the distal end 18 of the protective casing 20 in any other convenient manner instead of the double-hole hushing 16 as would be well within the capabilities of persons skilled in the art.

The electrically conductive components of the flow sensor probe 10 can comprise any electrically conductive material that is feasible for a desired application or operating environment. Persons skilled in the art are familiar with a variety of electrically conductive materials with a variety of qualities and characteristics for conductivity, temperature suitability, corrosion resistance, and the like, Appropriate materials for electrical conductors, e.g., the resistive sensor elements 40, 140, the strain relief wires 50, 52, 150, 152, and core wires 31, 32, 33, 34, 35, 36, 37, 38 that can withstand temperatures as high a 1,800° C. may include, for example, all platinum group metals, alloys comprising platinum (Pt) or rhodium (Rh), all refractory metals, e.g., niobium (Nb) or tungsten (W), alloys comprising refractory metals, e.g., molybdenum silicide (MoSi2), and very high temperature (VHT) polymer derived ceramics, e.g., SiBCN or SiAlCN. Other electrically conductive ceramics that can withstand temperatures as high as 1,800° C. may include lanthanum-based ceramics, titanium diboride (TiB2), titanium disilicide (TiSi2), refractory carbides or borides, indium tin oxide (ITO), conductive zirconia, or doped or undoped silicon carbonitride (SiCN). Gold (Au), silver (Ag), or palladium (Pd) can be used for electrical conductors in lower temperature applications, e.g., up to 1,000° C. Likewise, for the electrically insulative (dielectric) components described above, persons skilled in the art are familiar with a variety of electrically insulative (dielectric) materials that are suitable for a variety of applications and conditions, e.g., ceramics and single crystal materials (e.g., quartz or sapphire), amorphous materials, fused crystalline materials (e.g., fused silica, fused sapphire, etc.).

The foregoing description provides examples that illustrate the principles of the invention, which is defined by the claims that follow. Strain relief wires, such as the strain relief wires 50, 52 described above, can be used to connect wires that are subject to thermal expansion and contraction to any electrically conductive component that is subject to fracture from tensile or compressive stresses and strains in high temperature applications, including, for example, other sensors, transducers, pumps, valves, and actuators. Once persons skilled in the art understand the principles of this invention, such person will recognize that still other embodiments can also be used. Since numerous insignificant modifications and changes will readily occur to those skilled in the art once they understand the invention, it is not desired to limit the invention to the exact example constructions and processes shown and described above. Accordingly, resort may be made to all suitable combinations, subcombinations, modifications, and equivalents that fall within the scope of the invention as defined by the claims. The words “comprise,” “comprises,” “comprising,” “include,” “including,” and “includes” when used in this specification, including the claims, are intended to specify the presence of stated features, integers, components, or steps, but they do not preclude the presence or addition of one or more other features, integers, components, steps, or groups thereof.

The invention claimed is:

1. A method of connecting a wire that is subject to thermal expansion and contraction to an electrically conductive element that is subject to fracture when subjected to tensile or compressive stresses and strains, comprising:
joining one end of a length of strain relief wire, which has a bend, with the wire that is subject to thermal expansion and contraction; and
joining another end of the length of strain relief wire to the electrically conductive element that is subject to fracture.

2. The method of claim 1, wherein the length of strain relief wire that has the bend has small enough stiffness to flex in response to the thermal expansion and contraction of the wire that is subject to the thermal expansion and contraction.

3. The method of claim 1, wherein the length of strain relief wire that has the bend has small enough stiffness at a temperature in a range of 300° C. to 1,000° C. to flex in response to the thermal expansion and contraction of the wire that is subject to the thermal expansion and contraction.

4. The method of claim 1, wherein the bend has a coil shape.

5. The method of claim 1, wherein the bend has a loop shape.

6. The method of claim 1, wherein the bend has a bow shape.

7. The method of claim 1, wherein the bend has a double-bowed shape.

8. A method of assembling an electrically resistive sensor element in a tube, comprising:
placing a paste comprising a powder of thermally conductive fill material mixed with a binder into the tube;
forcing the electrically resistive sensor element into the tube to thereby force the paste comprising the powder of the electrically conductive fill material to flow around the electrically resistive sensor element in a gap between the electrically resistive sensor element and the tube; and;
heating the paste to cure the binder material.

9. The method of claim 8, including placing a sufficient quantity of the paste into the tube so that forcing the electrically resistive sensor element into the tube causes the paste to essentially fill the gap between the electrically resistive sensor element and the tube.

10. The method of claim 8, including placing the paste into the tube by injecting the paste into the tube before forcing the electrically resistive sensor element into the tube.

11. The method of claim 8, including coating the electrically resistive sensor element with the paste and forcing the electrically resistive sensor together with the paste into the tube.

12. Sensor apparatus comprising:
an electrically resistive sensor element;
a cable wire that is subject to thermal expansion and contraction; and
a length of strain relief wire which has a bend between two ends, wherein one of the two ends is joined to the cable wire and another of the two ends is joined to the electrically resistive sensor element.

13. The sensor apparatus of claim 12, wherein the length of strain relief wire which has the bend has small enough stiffness to flex in response to thermal expansion and contraction of the cable wire.

14. The sensor apparatus of claim 12, wherein the length of strain relief wire which as the bend has small enough stiffness at temperatures in a range of 300° C. to 1,000° C. to flex in response to thermal expansion and contraction of the cable wire.

15. The sensor apparatus of claim 13, wherein the bend has a coil shape.

16. The sensor apparatus of claim 13, wherein the bend has a loop shape.

17. The sensor apparatus of claim 13, wherein the bend has a bow shape.

18. The sensor apparatus of claim 13, wherein the bend has a double-bowed shape.

19. Sensor apparatus comprising:
an electrically resistive sensor element positioned in a tube with a gap between the electrically resistive sensor element and the tube; and
thermally conductive fill material in the gap between the electrically resistive sensor element and the tube.

20. The sensor apparatus of claim 19, wherein the thermally conductive fill material fills the gap between the electrically resistive sensor element and the tube.

21. An electrical device, comprising:
an electrically resistive element;
a thermally expandable and contractable wire; and
a length of strain relief wire which has a bend between two ends, wherein one of the two ends is joined to the thermally expandable and contractable wire and another of the two ends is joined to the electrically resistive element.

22. The electrical device of claim 21, wherein the length of strain relief wire which has the bend between two ends has small enough stiffness to flex in response to thermal expansion and contraction of the thermally expandable and contractable wire.
